(19) United States
(12) Patent Application Publication
(10) Pub. No.: US 2022/0002561 A1
(43) Pub. Date: Jan. 6, 2022

(54) A METHOD FOR REDUCING WATER CONTENT OF AN EPOXY OR/AND POLYURETHANE PAINT DISPERSION AND AN EPOXY OR/AND POLYURETHANE PAINT DISPERSION

(71) Applicant: Wisespray International Oy, Veikkola (FI)

(72) Inventor: Hendrik VAN DER NET, Scharnegoutum (NL)

(21) Appl. No.: 17/296,848

(22) PCT Filed: Nov. 26, 2019
(86) PCT No.: PCT/FI2019/050841

§ 371 Date: May 25, 2021

(30) Foreign Application Priority Data
Nov. 26, 2018 (FI) 20186001

(51) Int. Cl. C09D 5/02; C09D 7/63; C08G 18/08; C08K 5/29; C08K 5/41; C08K 5/353; C09D 163/00; C09D 175/04; B65D 83/14

(52) U.S. Cl. CPC C09D 5/021; C09D 5/024; C09D 7/63; C08G 18/0885; C08K 5/29; C08K 5/435; C08K 5/353; C09D 163/00; C09D 175/04; B65D 83/752; C08K 5/41

(57) ABSTRACT

The invention relates to a method for reducing water content of an epoxy or/and polyurethane paint dispersion to be prepared in a sealed and pressurized aerosol can which paint dispersion comprises, —free water of an amount W1, —organic solvent(s) of an amount W2,5-epoxy or/and polyurethane resin of an amount W3, —liquefied propellant of an amount W5, —ketone of an amount W6, —blocked hardener (hardener precursor) of the epoxy or/and polyurethane resin of an amount W4, wherein said blocked hardener compounds of said epoxy or/and 10 polyurethane resin is selected from the group comprising of an aldimine, an enamine, an imine, a Mannich base, a Schiff's base, an oxazolidine or a bisoxazol-idine, and mixtures thereof, —adjuvants, —water scavenger(s), —catalytic amount of a weak acid to shift equilibrium of reversible reaction (I) between the free water present in said dispersion and blocked hardener compounds of the epoxy or/and polyurethane resin back to formation of said initial epoxy or polyure-thane blocked hardener compounds and to prevent formation of the epoxy or/and polyurethane hardener amines: expoxy and/or polyurethane hardener+ketones catalyst expoxy and/or polyurethane+free water (amine) hardener precursor (1). The method comprises a step in which before providing organic solvent into the aerosol can its water content is reduced by admixing reactant with sulfonyl isocya-nate functionality as a water scavenger into said organic solvent.

The present invention relates to a method for reducing water content of an epoxy or/and polyurethane paint dispersion in a sealed and pressurized aerosol can which paint dispersion, further defined in claim 1.

The present invention also relates to an epoxy or/and polyurethane paint dispersion in a sealed and pressurized aerosol can from which paint dispersion the amount of water has been reduced by the method defined in claim 1.

The present invention further relates to a method for preparing epoxy or/and polyurethane paint dispersion and the paint dispersion prepared with said method.

The present invention further relates to a liquid mixture, for preparing paint dispersion.

A variety of aerosol formulations for aerosol paint and adhesive systems, packed in cans have been known for years. One-component aerosol paint and adhesive formulations have been the most important ones, but two-component paint and adhesive systems composing of two-component paint or adhesive formulations have been gaining more importance in the last few years.

The one-component aerosol formulations are suitable for use in conventional aerosol cans, that is, in aerosol cans having only one chamber. The two-component aerosol formulations are usually suitable only for aerosol cans having at least two chambers.

Two-component aerosol paint and adhesive systems comprise a binder, a curing component such as hardener or cross-linking component, a propellant and optionally a solvent in an aerosol can. The binder and the hardener are typically packed in separate chambers in the aerosol can. These types of aerosol cans are also referred to as “can in a can” cans or “2-chamber” cans. Just before using the can one of the chambers is punctured so that the binder and the hardener are brought into contact with each other inside the can. Reaction between the binder and hardener starts immediately when they are contacted in the can and the aerosol formulation is ready to be used for spraying.

Polyurethane system is one example of a two-component aerosol paint system. The two-component polyurethane aerosol formulation comprises a binder component, a hydroxyl group containing acrylate or polyester resin, and a polyisocyanate as curing component in a separate chamber. Aerosol paint cans of this type are employed to apply primers, undercoats, finishing coats, etc., primarily for vehicles such as passenger cars, trucks, busses, railroads, and containers.

An epoxy system is another example of a two-component aerosol paint and adhesive system. The epoxy system comprises an epoxy resin parent compound as binder and usually an amine as hardener. The two-component epoxy systems are used, additionally to automotive purposes, for general industrial and household industrial purposes, for building sector, machinery construction industry etc.

Epoxy resin or polyurethane resin based paint and adhesive systems, utilizing one compartment i.e. single chamber cans are available, as well. In these systems the individual reactive components, that is said epoxy or polyurethane resins and their curing precursors are in latent form before taking the can into use. However, there are two main drawbacks in these solutions; either they do not tolerate moisture at all. This leads easily to a limited shelf-life. Alternatively, good quality paints cannot be prepared from them.

In the prior art these solid and liquid water scavengers are used to block the effect of the ambient moisture in epoxy resin based paint and adhesive formulas by affecting the ketone-imine balance and thus formation of hardener compound amines for epoxy or polyurethane resin(s) in reactions (1a-1c):

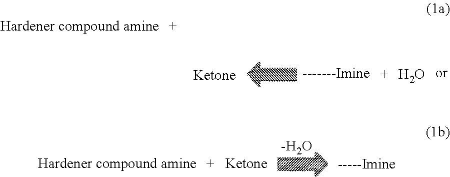

Wherein imine is precursor of epoxy or polyurethane hardener compound amine.
(1b).

Which can also be presented as a reversible reaction equilibrium:

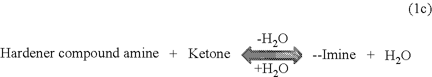

By removing water from the right side of the hydrolyzing reaction (1a) or by removing water from eliminating stage in condensing reaction (1b) with water scavengers, one can either prevent the amines (epoxy or polyurethane hardener compounds) to be formed in reaction (1a) or to shift reaction equilibrium (1b) to favor forming imines (epoxy or polyurethane resin hardener precursors) instead of amines (epoxy or polyurethane resin hardeners). In the prior art the inventors have added big amounts of water scavengers to control the formation of epoxy or polyurethane hardeners in the above mentioned reaction (1a) between imine and water. Removing water with scavengers shifts also reaction (1b) into formation of more imines. However, water scavengers itself are not paint related material but will affect for instance to the gloss and adhesion of the paint surface and therefore they are more suitable to be used in connection with preparing primers.

The reactions (1a) and (1b) can also be controlled by adding into the paint dispersion a catalytic compound such as weak acid, to prevent formation of the epoxy or/and polyurethane hardener amines from said epoxy or/and polyurethane hardener precursors. This catalytic compound shifts the equilibrium of the reversible reaction (2a) between the free water present in said dispersion and epoxy or/and polyurethane hardener precursor back to formation of said initial epoxy or polyurethane hardener precursors:

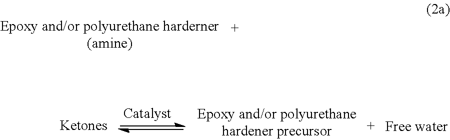

However, the inventors have now found that adding weak acid to control reversible reaction (2a) is not enough in all circumstances to ensure gaining good quality paint surface. This seems to be connected to a very high amount of free water (not bound) which may be brought into paint dispersion in aerosol can with raw materials (mainly with solvent or propellant).

The above prior art as a starting point, the main objective of the present invention is to ensure low enough water content in paint dispersion present in an aerosol can regardless of the moisture content of raw material of paint dispersion.

The second objective of the present invention is to adjust the moisture content in paint dispersion present in an aerosol can into a range in which the blocked hardeners can be kept as a blocked using the weak acid controlled reversal reaction (2a).

The third objective of the present invention is to use water scavenger for lowering water content of aerosol paint raw material so, that is still will enable making paint with high gloss.

The above objectives can be gained with the method defined in claim.

To be more exact the present invention relate to method for reducing water content of an epoxy or/and polyurethane paint dispersion to be prepared in a sealed and pressurized aerosol can. Said paint dispersion comprises:
free water of an amount W1,
organic solvent(s) of an amount W2,
epoxy or/and polyurethane resin of an amount W3,
blocked hardener (hardener precursor) of the epoxy or/and polyurethane resin of an amount W4,
liquefied propellant of an amount W5,
ketone of an amount W6,
catalytic amount of a weak acid
adjuvants,
water scavenger(s).

In said paint dispersion blocked hardener compounds of said epoxy or/and polyurethane resin is selected from the group comprising of an aldimine, an enamine, an imine, a ketimine, a Mannich base, a Schiff's base, an oxazolidine, and mixtures thereof.

In a presence of ketone(s), the weak acid will shift equilibrium of reversible reaction (2a) between the free water present in said dispersion and blocked hardener compounds of the epoxy or/and polyurethane resin back to formation of said initial epoxy or polyurethane blocked hardener compounds. This will prevent the formation of the epoxy or/and polyurethane hardener amines:

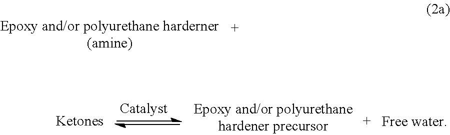

According to the first embodiment of the invention, before providing organic solvent into the aerosol can, that its water content is reduced by admixing sulfonyl isocyanate reactant as a water scavenger into said organic solvent.

According to the second embodiment of the invention, before providing organic solvent into the aerosol can, its water content is reduced by admixing water scavenger into said organic solvent, which water scavenger is selected so that, it will enable making of high paint surface with a high gloss, which a gloss is in the range of 10-100.

Present invention also relates to a method for preparing epoxy or/and polyurethane paint dispersion. In said method
before providing the organic solvent into the aerosol can the water content of said solvent is reduced by admixing sulfonyl isocyanate reactant as a water scavenger into said organic solvent and
reacting reactant with sulfonyl isocyanate functionality with free water supplies additionally sulfonamide into said paint dispersion of an amount W7.

The invention also relates to an epoxy or/and polyurethane paint dispersion in a sealed and pressurized aerosol can from which paint dispersion the amount of water has been reduced by the method defined in claim 1 or 2, which paint dispersion contains:

(a) epoxy or/and polyurethane resin 3-15, % w/w

(b) oxazolidine 1-5% w/w

(c) organic solvent, which includes ketone 10-50% w/w

(d) DME 15-40% w/w

(e) color or primer pigments up to 15%

(f) adjuvants up to 5 w/w %

(g) free water 50-1000 ppm, preferable 50-500 ppm

(h) weak acid 0.0510% w/w, preferable 0.50-2% which weak acid is a carboxylic acid (XCOOH), selected from the group which have the pKₐ value in the range from 1.2 to 9, preferable 1.2-5.2,

(i) p-toluene sulfonamide of an amount 0.2-10% w/w of an amount of 0.2-4% w/w wherein the amount of compounds (a)-f), adds up to 90% w/w of the total volume of the paint forming solution and the rest of the solution composes of carbinolamines, (h) weak acid, (g) free water and (j) p-toluene sulfonamide.

The amount of weak acid present in final paint forming solution in comparison to a amount of blocked hardener should be about mole of weak acid per five moles of blocked hardener.

Additionally, the present invention relate to a liquid mixture for preparing paint forming solution. This liquid mixture is prepared by admixing following chemicals in any order with each other: a solvent, a ketone, a weak acid, a blocked hardener precursor for epoxy resin or/and polyurethane resin having at least amine functionality, wherein
said blocked epoxy or/and polyurethane hardener precursor for epoxy resin or/and polyurethane resin is selected from the group comprising of an imine, an enamine, a ketimine, a Mannich base, a Schiff's base, an aldimine, an oxazole preferable an oxazolidine and mixtures thereof to be used with said weak acid for preventing epoxy resin hardener compounds or/and polyurethane resin hardener compounds to be formed from said blocked epoxy or/and polyurethane hardener precursor,
possible epoxy resin is selected from the group which comprises bisphenol A epoxy resin, bisphenol F epoxy resin, novolac epoxy resin, aliphatic epoxy resin and glycidylamine epoxy resin, or mixtures thereof,
possible polyurethane resin is selected from the group which comprises MDI, HDI, IPDI, TDI and phenol blocked TDI prepolymers.

Prepared liquid mixture comprises free water brought alongside with said chemicals and reactant with sulfonyl isocyanate functionality for reducing free water content of liquid mixture is also admixed into said liquid mixture.

The inventive main idea behind the present invention is to use of water scavengers for reducing the moisture content or paint material related ingredients before adding them into an aerosol can. A very important aspect of the present invention is to use water scavenger, which do affect negatively to film forming process and thus will enable making also high gloss paints.

Additionally, the amount of the water scavengers is also important; the amount of a water scavenger should be adjusted so, that it will bind excessive water from raw material but will enable keeping the equilibrium of the reversible reaction (2a) between ketones, weak acid, free water and epoxy or/and polyurethane hardener precursors.

Use of water scavengers has been in prior art connected in making paint with inferior paint surface; usually water scavengers tend to prevent making high quality paints because surface of paint film will remain soft or brittle. Making a clear coat high gloss or a colour high gloss is also impossible if high amount of water scavengers are used in an aerosol formulation to control formation of epoxy hardeners. For example, the abstract of JP2004035947 discloses a two component aerosol paint formulation for an aerosol can. The formulation comprises an epoxy resin such as bisphenol A type, an imine as hardener precursor and a propellant. Zero ambient moisture for the precursors is said to be a key requirement for preparing these paints. Additionally, in this patent document it has been proposed that ensuring the dry conditions should be done by adding water scavengers. However, the added amount of water scavengers seems to be so high, that it has affected negatively to paint quality and therefore the primary use of the disclosed two component aerosol of this kind is as a primer with gloss <5.

When making epoxy of polyurethane paint dispersions following chemicals/raw materials can be used to form the paint dispersion into the sealed aerosol can:

Epoxy or/and polyurethane resins.

Polyurethane resin is a urethane polymer, which is an isocyanate base compound available as a monomer or as a prepolymer.

Weak acid. In the present invention by a weak acid is meant an acid that dissociates incompletely, releasing only some of its hydrogen atoms into the solution.

Epoxy and/or polyurethane hardener precursors, which are selected from the group consisting of an imine, a ketimine, an enamine, a Mannich base, a Schiff's base, aldimine, oxazolidine and mixtures thereof.

Epoxy hardener precursors are nitrogen containing chemicals which form an amine when hydrolyzed. Preferable hardener precursors for epoxy resins are ketimines but all above mentioned hardener precursors will also work fine.

Preferable polyurethane hardener precursors (blocked polyurethane hardeners) are chemicals which form amine or/and polyol functionality when hydrolyzed. In the presence of water, the blocked polyurethane hardeners will form an amine and in the case of aldimine and oxazolidine they will form an amine and a polyol. Preferable blocked polyurethane hardeners are those which will direct polyurethane resins to react via pathway (b) (d) of FIG. 1.

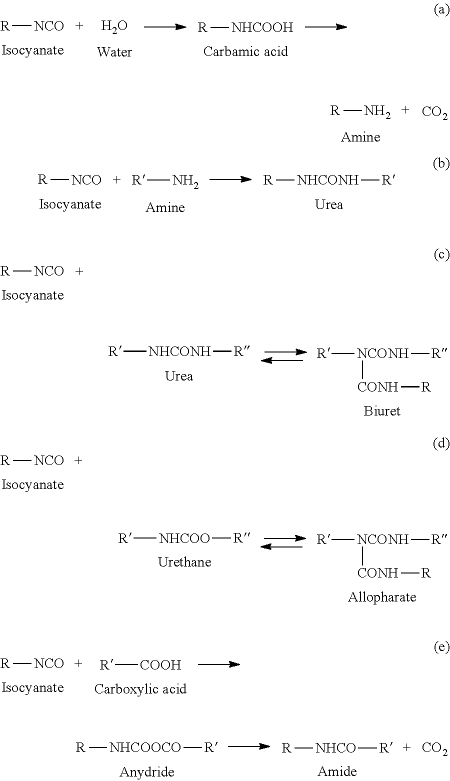

FIG. 1: Possible Isocyanate Reactions

Ketones (methyl-ethyl ketone, acetone MIBK, cyclohexanone etc. . . . ). These are necessary in the stabilizing of the environment inside the aerosol can.

Xylene and other aromatic solvents, aliphatic hydrocarbons, methoxy ether's, acetates, esters, ethers etc. . . . These solvents are not part of any reaction.

Additives: usual paint additives are supporting flow, leveling, anti-shagging, gloss, wetting, adhesion, flexibility etc. . . . . These additives are all non-reactive.

Propellants: Dimethyl-ether, propane, butane, 1,1,1,2-tetrafluorethaan, N20. Preferable propellant is Dimethyl-ether (DME).

Free Water: All the above mentioned solvents and propellant already contain free water. The average amount of free water in a formulation is by this fact already between 50-2000 ppmr, preferably 50-500 ppm.

By manufacturing and mixing the paint under normal environmental conditions the paint will contain 2000-10000 ppm water (0.2-0.8% analyzed by the Karl Fischer titration). By using water-scavengers having sulfonyl icosyanate functionality for reducing the water content of the solvent system the amount of water in the paint dispersion inside the closed can be reduce to 50-2000 ppm (0.005-0.2%) calculated from total weight of the paint dispersion.

This means the sealed end product inside the aerosol can can contains between 50-2000 ppm (=0.005-0.2%) of water preferably 50-500 ppm of water. This means for a 400 ml aerosol (density content appr. 0.75 gr/ml) between 0 and 3 gr of water.

Products have been tested on performance and shelf life with these amounts of water and show no defects in stability and performance after accelerated tests that correspond with shelf lives of appr. 3 years.

Aerosol can forms a completely closed environment, which is not influenced by the outside environment, with one exception, temperature.

This means an excellent environment to stabilize a mixture that will be stable as long it stays in this sealed environment. The only thing that can happen for the dispersion inside the aerosol can is that a part or all said dispersion is sprayed out of the can. Inside the can is a homogenous mixture which means that the material that stays in said stable environment will not change in other word will remain as it was.

The influence of changing environment temperatures outside the can are limited to a fluctuation in pressure inside the can. Test by storing on 50° C. and −20° C. show no difference in shelf life and performance when the cans are back to approximately 20° C. which is the average using temperature of an aerosol can.

The definition aerosol can, means herein that inside the aerosol can there is a room wherein at least part of the epoxy or polyurethane resin based paint and adhesive system, such as epoxy resin or polyurethane resin and their hardener precursors, co-exist as a mixture for extended time period of storing.

The paint means herein, primer, undercoat, finishing coat, top coat, coloured top coat, varnish or lacquer.

In the present invention by epoxy hardener or polyurethane hardener is meant a chemical compound capable of acting as a hardener for an epoxy resin or a polyurethane resin such as an amine that is formed when the hardener precursor such as imine, enamine, aldimine, oxazolidine, Schiff's base and/or Mannich base reacts with water. The hardener of the present invention is able to react with the epoxy resin or the polyurethane resin used for providing the desired coating layers i.e. paint or adhesive.

In the present invention by hardener precursor or more specifically epoxy hardener precursor or polyurethane precursor is meant a chemical compound capable of forming an (epoxy or polyurethane) hardener i.e. containing the suitable amine produced by a chemical reaction.

As used herein, the term free water refers to molecular water present in the formulation that is available to react with other component in the formulation. This includes, but is not limited to, water dissolved in the paint dispersion or in the gaseous portion of the aerosol can. The term “free water” excludes water that is not available for reactions such as water bound to e.g. inorganic salts (as hydrates) or water sequestered in e.g. molecular sieves or other desiccants or water scavengers.

As used herein, the term water scavenger refers to a substance or chemical compound that has the ability to remove free water from the composition. The water scavenger may either be one that physically sequesters the water molecules within its structure such as molecular sieves or silica gel, or chemically reactive compounds that bind the water in a chemical reaction that produces one or more new chemical species.

By ambient is meant the typical environmental conditions, temperature, pressure and humidity, prevailing at the point of preparation of the formulation at regular industrial surroundings.

In a case the epoxy hardener precursor or polyurethane hardener precursor is imine, the reversible hardener precursor reaction with water results an amine and a ketone. However, in the presence of catalytic amount of weak acid such as carboxylic acid, this reaction is shifted to favor the formation of initial imines instead of amines, thus preventing formation of amine hardeners of epoxy resin as follows:

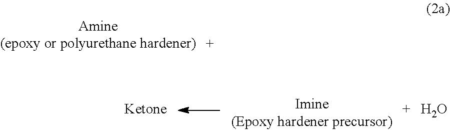

As said before a weak acid is an acid that dissociates incompletely, releasing only some of its hydrogen atoms into the solution.

Thus, it is less capable than a strong acid of donating protons. Weak acids ionize in water solution only to a moderate extent. If the weak acid is represented by the general formula HA, then in an aqueous solution a significant amount of undissociated HA still remains. Weak acids dissociate in water in the following way:

HA_{(aq)} [symbol] H⁺_{(aq)}+A⁻_{(aq)}

The strength of a weak acid may be represented by an equilibrium constant or percentage of dissociation. The equilibrium concentrations of reactants and products are related by the acid dissociation constant, Kₐ:

$${K}_{a} = \frac{[ {H}^{+} ] [ {A}^{-} ]}{[ HA ]}$$

The greater the value of Kₐ, the more the formation of H+ is favored, and the lower the pH of the solution. The Kₐ of weak acids typically varies between 1.8×10-16 and 55.5. For many practical purposes it is more convenient to discuss using the logarithmic constant, pKₐ

pKₐ=−log₁₀Kₐ

A weak acid typically has a pKₐ value within the approximate range from −2 to 12 in water.

In the present invention the weak acid is selected from the group which has the dissociation constant pKₐ value in the range from 1.2 to 9.9 preferably from 1.2 to 5.2.

The prepared aerosol dispersion contains preferably a catalytic amount of weak acid which is from 0.01 to 10% by weight (w/w) of the aerosol dispersion, preferably from 0.05 to 5%, more preferably from 0.05 to 2%.

Preferably, all components of the aerosol formulation can be placed within a common single chamber in an aerosol can without the components essentially reacting with each other during storing.

It is important to keep the amount of the weak acid so small that it will not have any negative influence on the quality of the coating. The weak acid is needed only a catalytic amount in the present method. This catalytic amount of a weak acid means that there is 0.01 to 10% of weak acid by weight (w/w) of the aerosol dispersion, preferably from 0.05 to 5%, more preferably from 0.05 to 2% of weak acid by weight (w/w) of the aerosol dispersion.

In a preferable embodiment of the present invention the weak acid is added into paint forming dispersion an amount that will contribute to a higher adhesion to the paint surface by etching.

The use of catalytic amount of weak acid in the present method and the aerosol dispersion used in this method enables making high quality paints regardless if all of it is used at once or reused after an extended time period.

A two-component aerosol dispersion containing paint forming chemicals comprising at least one epoxy resin and at least one hardener precursor, and at least one propellant. The formulation further contains at least a portion of a weak acid having the pKₐ value in the range from 1.2 to 5.2.

In one embodiment the weak acid is selected from those having pKₐ value within the range from 3 to 5, for efficiently maintaining the equilibrium of the formulation at the hardener precursor's side.

In another embodiment the weak acid is selected from those having the pKₐ value within the range from 4.2 to 4.9 for optimized stability in storage and performance in use.

Naturally, the type of weak acid has a further influence on the formulation properties, as well as the amount of weak acid used. Preferably, the weak acid is selected from the group consisting of carboxylic acids.

In one embodiment the weak acid to be applied comprises formic acid (methanoic acid) HCOOH (pKₐ=3.8), acetic acid (ethanoic acid) CH₃COOH (pKₐ=4.7), propionic acid (propanoic acid) CH₃CH₂COOH (pKₐ=4.9), butyric acid (butanoic acid) CH₃CH₂CH₂COOH (pKₐ=4.8), valeric acid (pentanoic acid) CH₃CH₂CH₂CH₂COOH (pKₐ=4.8), caproic acid (hexanoic acid) CH₃CH₂CH₂CH₂CH₂COOH (pKₐ=4.9), oxalic acid (ethanedioic acid) (COOH)(COOH) (pKₐ=1.2), lactic acid (2-hydroxypropanoic acid) CH₃CHOHCOOH (pKₐ=3.9), malic acid (2-hydroxybutanedioic acid) (COOH)CH₂CHOH(COOH) (pKₐ=3.4), citric acid (2-hydroxypropane-1,2,3-tricarboxylic acid) CH₂(COOH)COH(COOH)CH₂(COOH) (pKₐ=3.1), benzoic acid (benzenecarboxylic acid or phenylmethanoic acid) C₆H₅COOH (pKₐ=4.2) or carbonic acid (hydroxymethanoic acid) OHCOOH or H₂CO₃ (pKₐ=3.6). Preferably, the weak acid is acetic acid, benzoic acid, propionic acid or mixtures thereof, as these are the most efficient weak acids for the preferred hardener precursors of the present invention.

In one embodiment the weak acid is propionic acid, having a high pKₐ value.

In another embodiment the weak acid is acetic acid. Acetic acid has the advantage that it is a volatile liquid which readily evaporates when sprayed.

In yet another embodiment the weak acid is benzoic acid. This acid is a solid which facilitates the handling in preparation.

The amount of acid is dependent on the pKₐ value of the acid, the higher the pKₐ, the less acid is required.

Preferably, the amount of the weak acid to be added into the formulation of the present invention is from 0.01 to 10% by weight (w/w) of the two-component aerosol formulation, preferably from 0.05 to 5.0%, more preferably from 0.05 to 2.0%. The amount of weak acid used depends on the type of acid, the pKₐ value, and the selected hardener precursor.

In the present invention in a sealed aerosol can is created a space where environmental circumstances are of zero influence and a weak acid is used to control the hydrolysis of the hardener precursors. The weak acid is not a part of any reaction but guarantees an environment which forces the preferred reaction between traces of water that might hydrolyze epoxy or polyurethane hardener precursors always react in the presence of a ketone so that the reaction (2a) results back to initial imine, ketimine, aldimine, Mannich base, Schiff's base or oxazolidine.

The weak acid will thus create an ongoing loop which keeps the amount of reactants (water, latent hardener precursors and epoxy and/or polyurethane resins constant between uses of the can. Using catalyst instead of water scavengers to change reaction (1a) pathway, gives a possibility to create a complete new and different range of quality products. In the prior art use of water scavengers in changing the pathway or reaction (1a) has lead making low gloss products such as primers and corrosion protectors.

The aerosol paint dispersion of the present invention comprises at least one solvent. Function of the solvent is to lower the viscosity of the epoxy resin and the hardener precursor. The solvent type and the amount of the solvent are selected in a way that the viscosity of the epoxy resin and the hardener precursor mixture is such that the mixture is viscous enough to be suitably sprayed with aid of the propellant from a regular aerosol can.

The solvent is preferably selected from a group consisting of ketones, acetates, glycol ethers, aromatic solvents, aliphatic solvents, or mixtures thereof. More preferably, the solvent is dimethyl ketone, methyl iso-butylketone, methyl ethyl ketone, xylene, 1-methoxy-2-propanol, di-propylene glycol methyl ether cyclohexanone, or mixtures thereof.

Viscosity of liquid phase of the formulation is preferably from 50 to 300 cSt, more preferably from 50 to 150 cSt, measured at 20° C. and at atmospheric conditions. By the liquid phase is meant mixture of the epoxy resin and the hardener precursor, and optionally the solvent.

The propellant may be any suitable propellant known in the art. Preferably, the propellant is selected from a group consisting of dimethyl ether, propane, butane, isobutene, nitrogen, dinitrogen oxide, 1,1,1,2-tetrafluorethane, or mixtures thereof. Most preferably, the propellant is dimethyl ether (DME).

The two-component aerosol formulation may further comprise any additional suitable additives, such as colorants, color pigments and curing accelerators. Preferred colorants and color pigments are iron(II)oxide, iron(III)oxide, phatalo green, titanium(II)oxide and carbon black.

The aerosol dispersion of the present invention comprises at least one latent hardener precursor which is selected from the group consisting of an imine, an enamine, an oxazolidine or a bisoxazolidine, a Mannich base, a Schiff's base, aldimine and mixtures thereof.

In a preferred embodiment of the present invention, by selecting a proper latent hardener precursor (=blocked hardener) one is able to choose the drying time of the paint surface between 5-90 minutes.

The imine can be a Schiff's base, enamine, aldimine, oxazolidine, or Mannich base does not substantially react with the epoxy or polyurethane resin as such, when no water is present, for example inside a dry aerosol can atmosphere. As soon as the imine, enamine, aldimine, oxazolidine and/or Mannich, Schiff's bases are in contact with water, the water reacts with the hardener precursor, and as a result of this reaction an amine reactant is formed. Subsequently, the formed amine compound functions as hardener and reacts with the epoxy resin providing the coating.

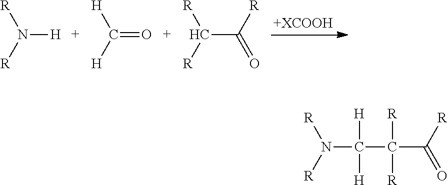

When the two-component aerosol formulation of the present invention is sprayed from an aerosol can, a cloud of particles suspended in gas or air is formed effectively picking up moisture from the air due to large surface area. The moisture or water will react with the hardener precursor of the formulation forming the amine compound (a hardener). The formed amine compound reacts further with the epoxy or/and polyurethane resin. This reaction is also referred to as curing reaction. And, finally a coating or adhesive layer is formed on a substrate on which the formulation is sprayed.

Reaction scheme 1, as an example, the reversible reaction of an imine with water resulting in an amine and a ketone for an epoxy resin:

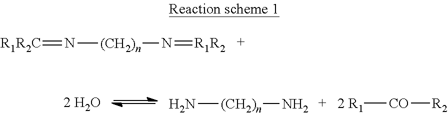

Reaction scheme 2 presents, as an example, the reversible reaction of an enamine with water resulting in an amine and a ketone:

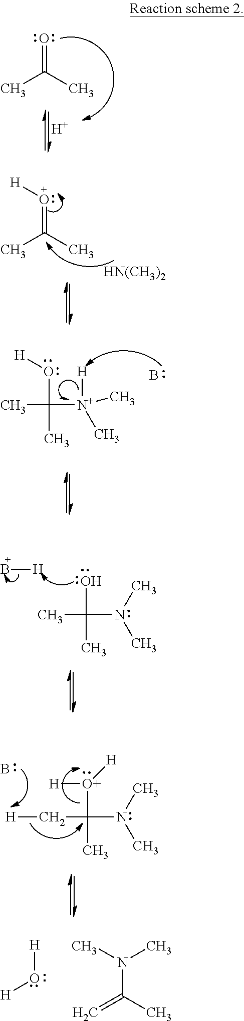

Mannich reaction is an organic reaction which consists of an amino alkylation of an acidic proton placed next to a carbonyl functional group by formaldehyde and a primary or secondary amine or ammonia. The final product is a β-amino-carbonyl compound also known as a Mannich base. Reactions between aldimines and α-methylene carbonyls are also considered Mannich reactions because these imines form between amines and aldehydes.

The Mannich reaction is an example of nucleophilic addition of an amine to a carbonyl group followed by dehydration to the Schiff's base.

Reaction scheme 3 presents, as an example, a reversible reaction of a Mannich base with water resulting in an amine and a ketone:

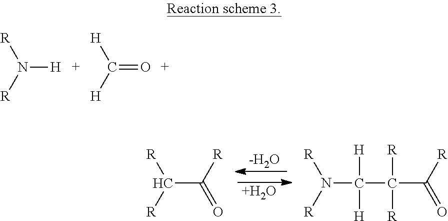

In one embodiment, the formed amine is primary, secondary or tertiary amine.

In one embodiment, the formed amine is mono-, di- or polyfunctional amine.

In one embodiment, the formed amine is aliphatic, cycloaliphatic or aromatic amine.

Preferred amines are di- and polyfunctional primary amines. The di- and polyfunctional primary amines undergo a reaction with an epoxide group of the epoxy resin to form a hydroxyl group and a secondary amine. The secondary amine can further react with an epoxide group to form a tertiary amine and an additional hydroxyl group.

In one embodiment the imines are reaction products of ethylenediamine and methyl isobutyl ketone; diethyl ketone-based di-imine, preferably N,N′-di(1-ethylpropylidene)-m-xylylenediamine, or mixtures thereof. Ethylenediamine and m-xylylenediamine are very good hardeners for epoxy coatings without side effects like Bernard cells and blushing. The solvent formed after hydrolysing the imine is compatible with the reaction product. The amine hydrogen equivalent weight (ANEW) values are in the dosage range of about 1:10 of binder.

In another embodiment enamine is a reaction product of 3,3,5-trimethylcyclohexanone with secondary diamines; a reaction product of isopheronediamine and methyl isobutyl ketone; N,N, bis(1,3-dimethyl-butylidine)ethylenediamine. The diamines give a higher reactivity than monoamines and provide therefore a faster hardening that can lead to a harder film but less flexible film formation.

In one embodiment aldimine is any Schiff base of the general formula RCH—NH or RCH—NR′ formed by condensation of an aldehyde with ammonia or a primary amine. Preferred aldimines are N-butyl-2-(1-ethylpentyl)-1,3-oxazolidine or 3-Oxazolidineethanol,2-(1-methylethyl)-,3,3-carbonate.

A wide range of imines and Mannich bases are commercially available. Also enamines and aldimines are commercially available. Suitable imines, enamines, aldimines and Mannich bases can also be synthesized with known procedures.

A wide range of imines and Mannich bases are commercially available. Also enamines and aldimines are commercially available. Suitable imines, enamines, aldimines and Mannich bases can also be synthesized with known procedures.

In one embodiment Mannich base is the reaction product between an aldehyde, such as formaldehyde, and a secondary amine, such as diethanol amine, in a weak acid environment dissolved in organic solvent, such as methyl ethyl ketone, as depicted by reaction scheme 4:

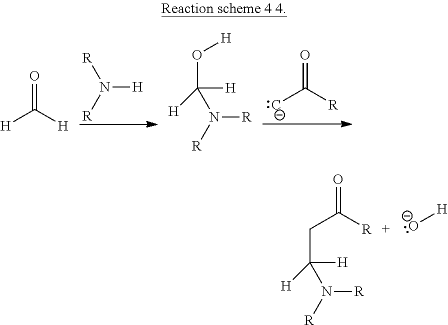

In yet another embodiment the Mannich base is Ancamine 1110 (Airproducts) i.e. dimethylaminomethylphenol as active ingredient, as depicted by FIG. 1:

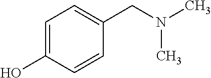

FIG. 1.

In yet another embodiment the Mannich base is selected from D.E.H™ 613, D.E.H™ 614, D.E.H™ 615, D.E.H™ 618, D.E.H™ 619 and D.E.H™ 620, or mixtures thereof, available commercially from company DOW.

The weight ratio between the epoxy resin binder to the hardener precursor is based on the epoxy molar mass of the binder and the equivalent weight of the hardener precursor, the amine content of the hardener precursor. The amount of hardener may vary +/−10%.

In one embodiment weight ratio of the epoxy resin to hardener precursor is from 8:1 to 15:1, preferably from 9:1 to 12:1, more preferably from 10:1 to 11:1 when using the preferred resins and hardener precursors.

In one embodiment the epoxy resin is an epoxy binder with an epoxy molar mass of 450-500, and the hardener precursor is a reaction product of ethylenediamine and methyl isobutyl ketone.

It was found by the inventors that the reversible Mannich base hardener precursor reaction with water discussed above resulting in an amine and a ketone may be modified using an addition of a weak acid into the reaction mixture. The reversible Mannich base hardener precursor reaction with water results in an amine and a ketone. The presence of weak acid such as carboxylic acid shifts this reaction equilibrium to the hardener precursor side thus preventing formation of these amine hardeners of epoxy resin or polyurethane resin as presented in reaction scheme (22a):

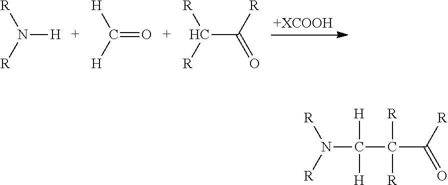

Reaction scheme 22 for an epoxy resin

In the present invention, the imine, enamine, aldimine and Mannich base, oxazolidine, bisoxazolidine Schiff's base are selected in a way that they react with water by forming an amine. Additionally, the imine, enamine, aldimine and Mannich base, oxazolidine Schiff's base are selected in a way that that they do not substantially react with the epoxy resin or/and polyurethane resin or other components inside an aerosol can.

Now the reaction balance favours the presence of the hardener precursor instead of the amine formation. By adjusting the amount, and type, of the weak acid to be added, the equilibrium of the amine formation reaction can be adjusted to favour the presence of the hardener precursor. The amount of weak acid depends on the pKₐ value of the acid.

When the amount of water increases considerably i.e. the ejected droplets of the formulation aerosol spray having a very small particle size, 75-100 micrometer, are exposed to environmental conditions and subjected into contact with ambient humidity the equilibrium will eventually shift to favour the formation of the amine. Moreover, the evaporation of the weak acid will further favour the reaction towards the forming of the amine which will enhance the reaction with the epoxy groups of the binder.

In a case polyurethane resin based paints are made, preferable latent hardener is oxazolidine. In the following example we have chosen N-Butyl-2-(1-ethylpentyl)1,3-oxazolidine:

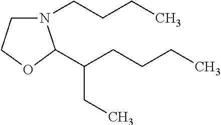 [SMILES: CCCCC(CC)C1OCCN1CCCC]

Reactions of this material in the can in the presence with water and a catalytic amount of carboxylic acid the following can happen:

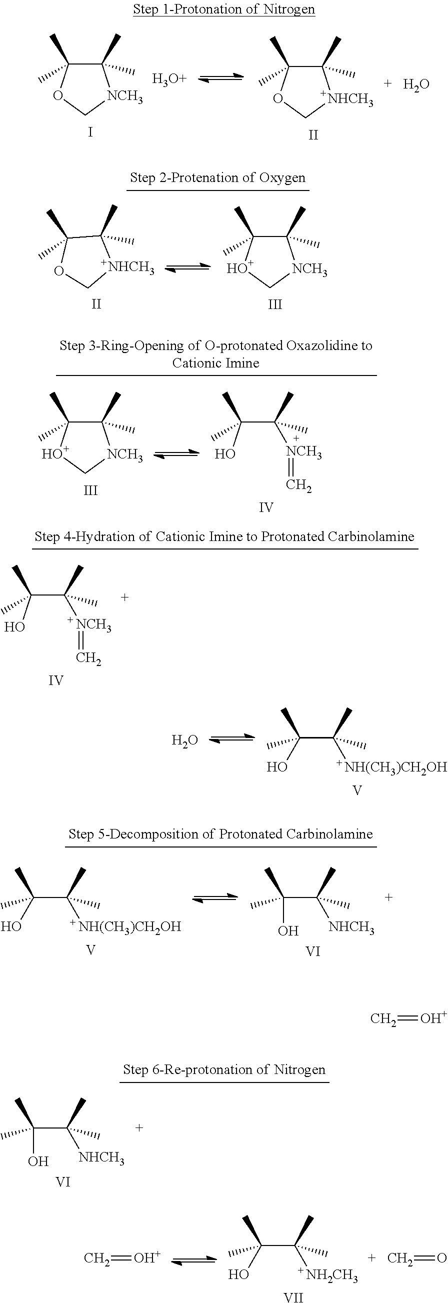

As shown in step 1 if water is available together with carboxylic acid it can lead to the end of step 3.

The carboxylic acid has a double function in this reaction:

1) The carboxylic acid makes the transformation possible to form an imine.

2) The carboxylic acid is the catalyst to prevent the forming of amine by catalyzing the preferred reaction between ketone and amine.

After step 3 the presence of ketone groups together with a catalytic amount of carboxylic acid forces in the case of hydrolyzing the imine, to the preferred reaction between the formed amine with the ketone group forming again an imine. This prevents the amine to react with the iso-cyanate groups of the MDI and HDI binders.

After spraying the paint mixture out of the can, the overload of water (humidity in air) together with the evaporation of the very volatile ketones will lead to a crosslinked coating.

In one embodiment, the formed amine is primary, secondary or tertiary amine.

In another embodiment, the formed amine is mono-, di- or polyfunctional amine.

In one embodiment, the formed amine is aliphatic, cycloaliphatic or aromatic amine.

Preferred amines are di- and polyfunctional primary amines. The di- and polyfunctional primary amines undergo a reaction with an epoxide group of the epoxy resin to form a hydroxyl group and a secondary amine. The secondary amine can further react with an epoxide group to form a tertiary amine and an additional hydroxyl group.

In one embodiment the imines are reaction products of ethylenediamine and methyl isobutyl ketone; diethyl ketone-based di-imine, preferably N,N′-di(1-ethylpropylidene)-m-xylylenediamine, or mixtures thereof. Ethylenediamine and m-xylylenediamine are very good hardeners for epoxy coatings without side effects like Bernard cells and blushing. The solvent formed after hydrolysing the imine is compatible with the reaction product. The amine hydrogen equivalent weight (ANEW) values are in the dosage range of about 1:10 of binder.

In another embodiment enamine is a reaction product of 3,3,5-trimethylcyclohexanone with secondary diamines; a reaction product of isopheronediamine and methyl isobutyl ketone; N,N, bis(1,3-dimethyl-butylidine)ethylenediamine. The diamines give a higher reactivity than monoamines and provide therefore a faster hardening that can lead to a harder film but less flexible film formation.

In one embodiment aldimine is any Schiff base of the general formula RCH—NH or RCH—NR′ formed by condensation of an aldehyde with ammonia or a primary amine. Preferred aldimines are N-butyl-2-(1-ethylpentyl)-1,3-oxazolidine or 3-Oxazolidineethanol,2-(1-methylethyl)-,3,3-carbonate.

In the case of the use of MDI and HDI prepolymers IPDI, TDI and phenol blocked TDI prepolymers the choice of oxazolidine is also made for its ability to avoid the forming of CO₂ by preventing the reaction between H₂O with the isocyanate by the preferred reaction between isocyanate and the formed amine. This together with the transparency of the oxazolidine makes it also possible to make a high quality transparent clear coat with high gloss.

Other latent hardeners that can also be in connection with MDI and HDI prepolymers IPDI, TDI and phenol blocked TDI prepolymers: imines, ketimines, aldimines, Schiff's Bases, Mannich Bases. In other words chemicals containing nitrogen with the ability to hydrolyze and form an amine, but can be stabilized in a stable nonchanging environment with the addition of a catalytic amount of carboxylic acid forcing a preferred reaction giving a “blocked Nitrogen” not being an amine.

In the paint dispersion of the present invention, the epoxy or/and polyurethane resin should not substantially react with the hardener precursor or with the weak acid of the paint dispersion.

In one embodiment, the formed amine is primary, secondary or tertiary amine.

In another embodiment, the formed amine is mono-, di- or polyfunctional amine.

In one embodiment, the formed amine is aliphatic, cycloaliphatic or aromatic amine.

In one embodiment, the epoxy resin is selected from the group consisting of bisphenol A epoxy resin, bisphenol F epoxy resin, novolac epoxy resin, aliphatic epoxy resin, glycidylamine epoxy resin, and mixtures thereof.

In one embodiment, the epoxy resin is bisphenol A epoxy resin. The bisphenol A epoxy resins are formed from reacting epichlorohydrin with bisphenol A. For example, the simplest bisphenol A epoxy resin is formed from reacting two moles of epichlorohydrin with one mole of bisphenol A to form bisphenol A diglycidyl ether (DGEBA). Increasing the ratio of bisphenol A to epichlorohydrin during manufacture produces higher molecular weight polyethers with epoxide groups (also referred to as glycidyl groups). This binder is particularly suitable for regular conditions. It has good water resistance and chemical resistance, and it provides flexible coatings.

In one embodiment, the epoxy resin is bisphenol F epoxy resin. The bisphenol F epoxy resins are formed from reacting epichlorohydrin with bisphenol F in similar way to bisphenol A. This binder has better chemical resistance compared to bisphenol A epoxy resins, especially at low and high pH ranges.

In one embodiment, the epoxy resin is novolac epoxy resin. The novolac epoxy resins are formed from reacting phenols with formaldehyde and subsequent glycidylation with epichlorohydrin. Examples of particularly suitable novolac epoxy resins are epoxy phenol novolacs (EPN) and epoxy cresol novolacs (ECN). These provide high chemical resistance together with a high temperature resistance. The formed films are less flexible when the epoxy group content is increased.

In one embodiment, the epoxy resin is aliphatic epoxy resin. The aliphatic epoxy resins comprise glycidyl epoxy resins and cycloaliphatic epoxides. These materials may act as dilutants, as well. They are preferably applied as auxiliary resins to the above discussed primary resins.

In one embodiment, the epoxy resin is glycidyl epoxy resin. The glycidyl epoxy resins are formed by reaction of epichlorohydrin with aliphatic alcohols or polyols to give glycidyl ethers or aliphatic carboxylic acids to give glycidyl esters. Examples of preferred glycidyl epoxy resins are dodecanol glycidyl ether, diglycidyl ester of hexahydrophthalic acid, and trimethylolpropane triglycidyl ether. The purpose of these chemicals is to provide a reactive dilutant for its low viscosity. Preferably, they are used in combination with the primary resins as auxiliary binders to balance the reaction taking place. Typically, their reaction rate is clearly lower to the primary resins.

In one embodiment, the epoxy resin is cycloaliphatic epoxide. The cycloaliphatic epoxides contain at least one cycloaliphatic ring in the molecule to which an oxirane ring is fused. The cycloaliphatic epoxides are formed by reaction of cyclo-olefins with a peracid, such as peracetic acid. An example of preferred cycloaliphatic epoxide is 3,4-epoxycyclohexylmethyl-3,4-epoxycyclohexane carboxylate. The purpose of these chemicals is to provide a reactive dilutant for its low viscosity. The reaction rate is lower to the primary resins.

In one embodiment, the epoxy resin is glycidylamine epoxy resin. The glycidylamine epoxy resins are formed when aromatic amines are reacted with epichlorohydrin. Examples of preferred glycidylamine epoxy resins are triglycidyl-p-aminophenol and N,N,N,N-tetraglycidyl-4,4-methylenebis benzylamine. These provide a very high temperature resistant coating and very high reactivity, as there as many epoxy groups in the chain.

In one embodiment a combination of selected different types of primary and auxiliary resins, and optional solvents, is used to ensure linear and steady evaporation of the solvents, and to enhance the forming of the coating and exhibiting desired properties.

A wide range of different epoxy resins, such as the ones mentioned above, are produced industrially and are commercially available.

The epoxide content is a characteristic feature of the epoxy resins. The epoxide content is commonly expressed as epoxide number, which is the number of epoxide equivalents in 1 kg of resin (Eq./kg), or as the equivalent weight, which is the weight in grams of resin containing 1 mole equivalent of epoxide (g/mol). One measure may be converted to another with formula:

Equivalent Weight (g/mol)=1000/epoxide number (Eq./kg)

Preferably, the epoxy resin of the present invention is selected from a group consisting of bisphenol A epoxy resin, bisphenol F epoxy resin, epoxy phenol novolacs (EPN), epoxy cresol novolacs (ECN), dodecanol glycidyl ether, diglycidyl ester of hexahydrophthalic acid, trimethylolpropane triglycidyl ether, 3,4-epoxycyclohexylmethyl-3,4-epoxycyclohexane carboxylate, triglycidyl-p-aminophenol, N,N,N,N-tetraglycidyl-4,4-methylenebis benzylamine, or mixtures thereof. More preferably, the epoxy resin of the present invention is selected from bisphenol A epoxy resin or bisphenol F epoxy resin. The characteristics of these two types of binders are the most suitable for the aimed products. They further enable the use of reactive dilutants of high temperature resistant type.

In one embodiment, the epoxy resin has an Equivalent Weight from 100 to 1500 g/eq, preferably from 120 to 700 g/eq, and more preferably from 450 to 500 g/eq.

In another embodiment the epoxy resin is an epoxy with an epoxy group content of 2000-2220 mmol/kg and an epoxy molar mass of 450-500 g/Eq.

In one embodiment the amount of epoxy by weight of the formulation is from 18 to 30%. Preferably, the amount of epoxy by weight of the formulation is from 15 to 30%. Most preferably, the amount of epoxy by weight of the formulation is from 15 to 23%

The weight ratio between the epoxy resin binder to the hardener precursor is based on the epoxy molar mass of the binder and the equivalent weight of the hardener precursor, the amine content of the hardener precursor. The amount of hardener may vary +/−10%.

In one embodiment weight ratio of the epoxy resin to hardener precursor is from 8:1 to 15:1, preferably from 9:1 to 12:1, more preferably from 10:1 to 11:1 when using the preferred resins and hardener precursors.

In one embodiment the epoxy resin is an epoxy binder with an epoxy molar mass of 450-500, and the hardener precursor is a reaction product of ethylenediamine and methyl isobutyl ketone.

In one embodiment the formulation according to the present invention contains 8-45%, preferably about 20% by weight epoxy binder with an equivalent weight of 120-800, preferably 475, which is preferably a bisphenol epoxy binder; and 1.5-35% by weight, preferably about 3.2% by weight of the hardener, which is preferably the reaction product of isophoronediamine and methyl isobutyl ketone; and 10-30% by weight, preferably about 18.3% by weight solvent, which is preferably 1-methoxy-2-propanol; and 10-30% by weight, preferably about 16.8% by weight of additional solvent, which is preferably butanon-2; and 0.05-3% by weight, preferably about 0.05-2% of the weak acid, for example acetic acid; and 25-45% by weight, preferably about 40% by weight propellant, which is preferably dimethyl-ether. This composition is especially well suited as fuel, water and chemical resistant clear coat.

In a further aspect, the present invention provides a method for producing a two-component aerosol formulation as depicted above wherein the formulation is prepared under ambient conditions. The method further provides for increasing the storage stability and shelf life of a two-component aerosol formulation when stored in a single chamber aerosol can.

By ambient conditions is meant regular environmental conditions typically comprising water vapour the amount dependent on the temperature and humidity, and water originating from precursor chemicals.

Typically, the stability without the acid and when prepared at water-free conditions using water-free precursors is about a few weeks or months. And especially, if traces of water remain in the can the stability of the formulation decreases rapidly.

Contrary to this the paint dispersion of the present invention is stable at least over a year, with preferred choice of precursors at least up to 3 years. Portion of paint dispersion can be sprayed/reused several times without any decrease in the storage stability of the rest of the paint dispersion.

Moreover, in the method of the present invention the preparation of the paint dispersion may be performed under ambient conditions simplifying the manufacturing considerably as no protection gasses or drying agents need to be applied. No nitrogen atmosphere is necessary to avoid excess water contamination. In prior art JP2004035947 nitrogen atmosphere is necessary to make a moisture free paint inside the aerosol can and still only prior quality paint is enabled.

In the preparation method according to the present invention merely a weakly acidic formulation is created by adding a suitable small amount of weak acid thus preventing immediate reactions of the hardener precursors with moisture.

In one embodiment the precursor chemicals, especially solvent, of the paint dispersion to be made, are treated with sulfonyl isocyanate reactant for removal of excess water with sulfonyl prior to application into the paint dispersion.

In one embodiment the paint dispersion of the present invention is prepared by first mixing the film forming chemicals comprising the epoxy resin or/and polyurethane resin and the hardener precursor (Schiff's nbase), and the weak acid having the dissociation constant pKₐ value in the range from 1.2 to 5.2. The obtained mixture is directed into a single chamber can. Subsequently, the propellant (for example DME) is introduced into the can, and the can is sealed, and ready for use.

In another embodiment of the present invention also propellant is treated with sulfonyl isocyanate reactant for removing excessive water.

In one embodiment, when the film forming chemicals comprise an auxiliary resin or solvent, the weak acid is first dissolved into the solvent, solvent and weak acid are treated with sulfonyl isocyanate reactant for removal of excess water with sulfonyl prior, after which at least one resin builder i.e. primary resin is introduced into this mixture. Subsequently, at least one hardener precursor is introduced thereto.

In one embodiment, the ketone comprising solvent system with 2-4 solvents are first mixed together. Solvent mixture is reacted with sulfonyl isocyanate reactant for removal of excess water with sulfonyl prior, Subsequently, the acid is introduced and mixed with the solvents. The primary, and optionally, the auxiliary resin builder(s) are introduced into the mixture, where after the hardener precursor(s) is introduced.

Preferably, after introducing all the compounds of the coating forming chemicals into the formulation, it is mixed fora short period, such as 15 min per 1000 l of formulation, prior to directing the mixture into cans and sealing the cans. Excess exposure to ambient should be avoided, if possible.

In a yet further aspect, the present invention provides an aerosol can containing the two-component aerosol formulation discussed above.

The mechanical vessel, the aerosol can, also referred to as a spray can or an aerosol spray can, may be any conventional aerosol can known in the art. Preferably, the aerosol can is a conventional aerosol can having one single chamber.

The aerosol can may be a 2-chamber aerosol can, commonly used for two-component aerosol formulations. In the 2-chamber aerosol can the hardener precursors are in one chamber and the epoxy resin in a separate chamber.

In the aerosol can having a single chamber all components of the formulation are in the same chamber. Examples of single chamber aerosol cans are straight-walled and necked-in cans.

Material of the aerosol can is metal based, for example, aerosol can is made of aluminium or tinplate.

Aerosol cans are commercially available in a diversity of diameters, heights, fill volumes, brim volumes and pressures. As for the shape, there is a wide range of variations available.

Special provisions apply for, especially metal, aerosol cans. These provisions are well known for a skilled person in the art. The special provisions define, for example, total capacities of aerosol cans, pressures of the aerosol cans, volume of liquid phase etc.

An example of such provision is, in Europe, “The Pressure Equipment Directive” (97/23/EC) together with: the directives related to simple pressure vessels (2009/105/EC), transportable pressure equipment (99/36/EC), and Aerosol Dispensers (75/324/EEC); for an adequate legislative framework on European level for equipment subject to a pressure hazard.

Aerosol cans are commercially available, for example from company G. Staehle GmbH u. Co. KG, Germany.

In one embodiment, the aerosol may additionally contain a small quantity of silica gel and/or molecular sieve filters to absorb excess water. The amount of the silica gel and/or molecular sieve filters is selected so that the silica gel and/or molecular sieve filters absorbs the excess water present in the formulation and in the can, and thus prevents the water from reacting with the hardener precursor inside the can.

In one embodiment the aerosol may additionally contains one or several mixing balls, preferably two mixing balls, which enhance mixing of the two-component aerosol formulation when the can is shaken before spraying. The mixing balls, also referred to as shaking balls or peas, are well known and commonly used in the art.

The two-component aerosol formulation of the present invention can be packed into an aerosol can with known procedures.

In one embodiment, first an epoxy resin or/and polyurethane resin, weak acid and solvent form which excessive water has been removed by reaction with sulfonyl isocyanate reactant, are mixed together. Optionally, color paste or other additives are added to the mixture and the mixing is continued. The hardener precursor is added to the mixture and mixing is continued. The obtained mixture is filled in a 1-chamber aerosol can with a liquid filling machine. Shaking balls may be added, a valve is put on the can and clinched on the can. The can is finally filled with a suitable amount of liquefied propellant through the valve. An actuator is put on the valve, and the can is ready to be used. All these procedures may be performed under ambient conditions.

The valve may be any common aerosol can valve used in the art. Suitable aerosol can valves are commercially available, for example from company Aptar GmbH, Germany.

The actuator may be any common actuator used in the art. Suitable actuators are commercially available. Example of such actuator is Aptar W2AX from company Aptar GmbH, Germany.

In addition to the weak acid application, the time between mixing and filling the formulation into an aerosol should be kept as short as possible in order to avoid unnecessary water contamination.

When the two-component aerosol formulation is sprayed from an aerosol can there should be a sufficient amount of water, such as humidity, present in the surrounding environment for the hardener precursor to react efficiently with the water to form the amine.

Preferably, the temperature of the environment during the spraying should be such that the two-component aerosol formulation is viscous enough to be sprayed. More preferably, the temperature is from 10 to 50° C., most preferably from 15 to 35° C., and even such as from 17 to 27° C.

In one embodiment the two-component aerosol formulation is used in underwater applications. The pressure inside the can is adjusted to overcome the ambient pressure. Preferably, water displacement additives are used to ensure sufficient contact of the paint spray to the surface to be coated.

The epoxy resin and/or formed amine combinations cure at ambient temperature. In one embodiment the curing is expedited by heating, with temperatures up to 75° C.

Spray pattern, when the aerosol formulation is sprayed from an aerosol can, is a fine mist of aerosol droplets forming a film on sprayed surface. The spray pattern can be flat, such as fan spray, or round depending on the actuator.

In one embodiment, the spray will give a dry film of approx. 15-20 μm after 1 cross layer, with a hardness of persoz hardness at least 180 sec. The coating layer is dust dry after 15 min, touch dry after 30 min, and sufficient hardened after 24 h.

More particularly, there is provided use of the aerosol can as defined above for applying coatings and adhesives.

In one embodiment, the two-component aerosol formulation of the present invention and the method for preparation thereof is used for providing a clear coat.

In one embodiment the aerosol can is used for spraying undercoats, finishing coats, varnishes, lacquers and adhesives.

The aerosol can may be used to spray adhesives, primers, undercoats, finishing coats, varnishes, lacquers, or other coatings in any suitable applications, such as industrial, automotive, marine, construction industry and/or flooring applications.

The following non-limiting examples will further illustrate the present invention.

Formulations with various carbolic acid and water contents with a maximum of 500 ppm in the end product.

Formulations and their Properties and (Examples

Following formulations were done using the general procedure shown in example 7.

Formula 1
Polyurethane clear coat high gloss. Consumer quality

| ingredient | % w/w |
|---|---|
| Acetone | 7.64 |
| Methoxy propyl acetate | 1.85 |
| Butyl acetate | 8.63 |

Water content1089 ppm calculated amount of sulfonyl isocyanate
1089/1.000.000 × (sum solvents) 18.12 × 18 = 0.36 mixed
in water check 14 ppm

| | |
|---|---|
| anti-foam agent | 0.32 |
| binder HDI (desmodur 3265 mpa/sn | 24.37 |
| Catalyst: Oleic acid | 0.30 |
| Leveling/anti slip agent | 0.24 |
| Oxazolidine blocked hardener | 6.29 |
| (incozol LV) | |
| Dimethyl ether | 50.00 |

Formula 2
Polyurethane clear coat semi-gloss. Consumer quality

| Ingredient | % w/w |
|---|---|
| Acetone | 7.64 |
| Methoxy propyl acetate | 1.85 |
| Butyl acetate | 8.63 |
| Fumed SiO2 | 1.50 |

Water content1089 ppm calculated amount of sulfonyl isocyanate
1089/1.000.000 × (sum solvents) 18.12 × 18 = 0.36 mixed
in water check 14 ppm

| | |
|---|---|
| Anti-foam agent | 0.32 |
| Binder; HDI (desmodur 3265 mpa/sn) | 24.37 |
| Catalyst: Oleic acid | 0.30 |
| Leveling/anti slip agent | 0.24 |
| Oxazolidine blocked hardener | 6.29 |
| (incozol LV) | |
| Dimethyl ether | 48.50 |

Formula 3
Polyurethane clear coat matt. Consumer quality

| Ingredient | % w/w |
|---|---|
| Solvent system: | |
| Acetone | 7.64 |
| Methoxy propyl acetate | 1.85 |
| Butyl acetate | 8.63 |
| Fumed SiO2 | 3.00 |

Water content of solvent system 1089 ppm calculated amount of sulfonyl
isocyanate 1089/1.000.000 × (sum solvents) 18.12 × 18 = 0.36
mixed in water check 14 ppm

| | |
|---|---|
| Anti-foam agent | 0.32 |
| Binder: HDI (desmodur 3265 mpa/sn | 24.37 |
| Catalyst Oleic acid | 0.30 |
| Leveling/anti slip agent | 0.24 |
| Oxazolidine blocked hardener | 6.29 |
| (incozol LV) | |
| Dimethyl ether | 47.00 |

Formula 4
Polyurethane clear coat high gloss. Profi quality

| Ingredient | % w/w |
|---|---|
| Solvent system: | |
| Acetone | 9.17 |
| Methoxy propyl acetate | 2.23 |
| Butyl acetate | 10.36 |

Water content of solvent system 1089 ppm calculated amount of sulfonyl
isocyanate 1210/1.000.000 × (sum solvents) 18.12 × 18 = 0.47%
mixed in water check 11 ppm

| | |
|---|---|
| Anti-foam agent | 0.39 |
| Binder: HDI (desmodur 3265 mpa/sn | 29.24 |
| Catalyst Oleic acid | 0.30 |
| Leveling/anti slip agent | 0.29 |
| Oxazolidine blocked hardener | 7.55 |
| (incozol LV) | |
| Dimethyl ether | 40.00 |

| Formula 5 | |
|---|---|
| Polyurethane clear coat semi-gloss. Consumer quality | |
| Ingredient | % w/w |
| Solvent system: | |
| Acetone | 9.17 |
| Methoxy propyl acetate | 2.23 |
| Butyl acetate | 10.36 |
| Water content of solvent system 1089 ppm calculated amount | |
| of sulfonyl isocyanate 1210/1.000.000 × (sum solvents) | |
| 18.12 × 18 = 0.47% mixed in water check 11 ppm | |
| Fumed SiO2 | 1.80 |
| Anti-foam agent | 0.39 |
| Binder: HDI (desmodur 3265 mpa/sn | 29.24 |
| Catalyst Oleic acid | 0.30 |
| Leveling/anti slip agent | 0.29 |
| Oxazolidine blocked hardener (incozol LV) | 7.55 |
| Dimethyl ether | 38.20 |

| Formula 6 | |
|---|---|
| Polyurethane clear coat Matt. Profi quality | |
| Ingredient | % w/w |
| Solvent system: | |
| Acetone | 9.17 |
| Methoxy propyl acetate | 2.23 |
| Butyl acetate | 10.36 |
| Water content 1089 ppm of solvent system: | |
| calculated amount of (p-toluene) sulfonyl | |
| isocyanate1210/1 .000.000 × (sum solvents) | |
| 18.12 × 18 = 0.47% mixed in water check 11 ppm | |
| Fumed SiO2 | 3.60 |
| Anti-foam agent | 0.39 |
| Binder HDI (desmodur 3265 mpa/sn | 29.24 |
| Catalyst Oleic acid | 0.30 |
| Leveling/anti slip agent | 0.29 |
| Oxazolidine blocked hardener (incozol LV) | 7.55 |
| Dimethyl ether | 36.40 |

| Formula 7 | |
|---|---|
| Epoxy primer | |
| Aceton | 37.50 |
| Dispersion agent | 0.30 |
| Primer compounds | 10.00 |
| Measured water content after dispersing 1725 ppm calculated | |
| sulfonyl-isocyanate 1725/1 .000.000 × 48.8 × 18 = 1.52% | |
| check after adding water content 17 ppm | |
| Epoxy binder Epilok 60-701 X75 | 12.00 |
| Colorants | 3.33 |
| Oleic acid | 0.30 |
| Ketimin blocked hardener curamine 88-891 | 1.45 |
| Dimethyl ether | 33.66 |

| Formula 8 | |
|---|---|
| Epoxy Filler | |
| Aceton | 30.47 |
| Dispersion agent | 0.30 |
| Primer/filler compounds | 12.94 |
| Measured water content after dispersing 1725 ppm calculated | |
| amount of sulfonyl-isocyanate 1725/1.000.000 × 43.71 × | |
| 18 = 1.36% check after adding water content 15 ppm | |
| Epoxy binder Epilok 60-701 X75 | 15.52 |
| Colorants | 2.20 |
| Oleic acid | 0.30 |
| Ketimin blocked hardener curamine 88-891 | 1.86 |
| Dimethyl ether | 35.05 |

Formulas for Polyurethane Clear Coat:

Formulas 8-11 contained sulfonyl-isocyanate 11-16 ppm (calculated amount)

| Formula 8 | % w/w |
|---|---|
| Acetone | 24.95 |
| Methyl Isobutyl Ketene | 12.00 |
| Prepolymer of Hexamethylen-1,6-diisocyanat | 15.00 |
| (Equivalent weight 350 NCO content 11%) | |
| Benzoic acid | 0.05 |
| 3-Oxazolidineethanol, 2-(1methylethyl)-, 3.3′-carbonate | 2.5 |
| Flow additive | 0.25 |
| Slip additive | 0.25 |
| Dimethyl ether (propellant) | 45.00 |
| water content before filling in the aerosol can | |
| 520 ppm gives a water content in the can of | |
| 286 ppm | |

Formula 9

| | |
|---|---|
| Acetone | 17.50 |
| Methyl Isobutyl Ketene | 12.00 |
| Prepolymer of Hexamethylen-1,6-diisocyanat | 20.00 |
| (Equivalent weight 350 NCO content 11%) | |
| Oleic acid | 2.00 |
| 1,6-hexanediyl-bis(2-(2-(1-ethylpentyl)3- | 8.00 |
| oxazolidinyl)ethyl)carbamate | |
| Flow additive | 0.25 |
| Slip additive | 0.25 |
| Dimethyl ether (propellant) water content | 40.00 |
| before filling in the aerosol can 455 ppm | |
| gives a water content in the can of | |
| 273 ppm | |

Formula 10

| | |
|---|---|
| Acetone | 23.10 |
| Methyl Isobutyl Ketene | 12.00 |
| Aromatic poly-isocyanate prepolymer | 20.00 |
| based on toluene diisocyanate | |
| (Equivalent weight 792 NCO content 5.3%) | |
| Propionic acid | 1.00 |
| 1,6-hexanediyl-bis(2-(2-(1-ethylpentyl)3- | 3.40 |
| oxazolidinyl)ethyl)carbamate | |
| Flow additive | 0.25 |
| Slip additive | 0.25 |
| Dimethyl ether (propellant) | 40.00 |

Formula 11

| | |
|---|---|
| Acetone | 24.95 |
| Methyl Isobutyl Ketene | 12.00 |
| Prepolymer of Hexamethylen-1,6-diisocyanat | 25.00 |
| (Equivalent weight 350 NCO content 11%) | |
| Decanoic acid | 0.50 |
| 3-Oxazolidineethanol, 2-(1methylethyl)-, 3,3′-carbonate | 4.25 |
| Flow additive | 0.25 |
| Slip additive | 0.25 |
| Dimethyl ether (propellant) | 45.00 |

In formulas 8-11 all the tests done with various amounts of water limited till 500 ppm in the end product and various types of carbolic acids with amounts between 0.05% till 2.5% w/w give excellent product results, Shelf life of at least 2 years

The types of Isocyanate Prepolymer and Oxazolidines (reacting as blocked hardeners) are free of choice as long as they are stoichiometric in balance. Calculation: (equivalent weight oxazolidine×100)/equivalent weight iso-cyanate prepolymer

Additives can vary but must be tested on stability with the reactive ingredients of the formulation.

Epoxy Primers, Fillers

Formulas 8-16 Contained Sulfonyl-Isocyanate 11-16 ppm (Calculated Amount)

| Formula 12: | % w/w |
|---|---|
| Acetone | 13.20 |
| Xylene | 5.00 |
| Butyl acetate | 10.00 |
| Flow additive | 0.30 |
| Epoxy binder (equivalent weight 475(75% in xylene) | 20.00 |
| Ketimine (equivalent weight 76) | 2.40 |
| calcium modified silica gel | 6.75 |
| Rheologic additive | 0.15 |
| Propionic acid | 0.60 |
| Wetting additive | 2.50 |
| TiO2 | 3.50 |
| Di-Methyl Ether | 38.00 |
| water content before filling in the aerosol can | |
| 485 ppm gives a water content in the can of | |
| 301 ppm | |

Formula 13

| | |
|---|---|
| Acetone | 12.90 |
| Xylene | 5.00 |
| Butyl acetate | 10.00 |
| Flow additive | 0.30 |
| Epoxy binder (equivalent weight 190 | 20.00 |
| Ketimine (equivalent weight 55) | 5.80 |
| calcium modified silica gel | 8.40 |
| Rheologic additive | 0.15 |
| Wetting additive | 2.50 |
| Oleic acid | 0.90 |
| TiO2 | 3.50 |
| Di-Methyl Ether | 38.00 |
| water content before filling in the aerosol can | |
| 442 ppm gives a water content in the can of | |
| 274 ppm | |

The types of epoxy binders can vary as well as the ketimines used as blocked hardener as long as they are stoichiometric in balance.

The PVC value (balance between binder and dry primer material) can vary from application to application between 35 and 55.

All the added ingredients must be tested on their compatibility with the reactive components in the formulation

The color of the end product can vary by using other color pigments than TiO2 as used in the test formulation. Usual color pigments for primers and fillers are carbon black, oxide red, oxide yellow etc. . . . .

Filler
formula 14

| | |
|---|---|
| Acetone | 10.31 |
| Xylene | 5.00 |
| Butyl acetate | 5.00 |
| Flow additive | 0.30 |
| Epoxy binder (equivalent weight 190 | 22.00 |
| Ketimine (equivalent weight 55) | 6.38 |
| calcium modified silica gel | 10.56 |
| Rheologic additive | 0.05 |
| Wetting additive | 2.90 |
| Benzoic acid | 2.00 |
| TiO2 | 3.50 |
| Di-Methyl Ether | 32.00 |
| water content before filling in the aerosol can | |
| 392 ppm gives a water content in the can of | |
| 267 ppm | |

formula 15

| | |
|---|---|
| Acetone | 15.34 |
| Xylene | 5.00 |
| Butyl acetate | 5.00 |
| Flow additive | 0.30 |
| Epoxy binder (equivalent weight 475 (75% in xylene) | 18.00 |
| Ketimine (equivalent weight 76) | 2.16 |
| calcium modified silica gel | 6.75 |
| Rheologic additive | 0.05 |
| Wetting additive | 2.90 |
| Benzoic acid | 1.00 |
| TiO2 | 3.50 |
| Di-Methyl Ether | 40.00 |
| water content before filling in the aerosol can | |
| 422 ppm gives a water content in the can of | |
| 313 ppm | |

The types of epoxy binders can vary as well as the ketimines used as blocked hardener as long as they are stoichiometric in balance.

The PVC value (balance between binder and dry primer material) can vary from application to application between 35 and 55.

All the added ingredients must be tested on their compatibility with the reactive components in the formulation

The color of the end product can vary by using other color pigments than TiO2 as used in the test formulation. Usual color pigments for primers and fillers are carbon black, oxide red, oxide yellow etc. . . . .

Colored Top coat Epoxy

The principle for the colored top coats is the same as for the epoxy primers and fillers.

The epoxy binders can vary (equivalent weight from 190-2000) in stoichiometric balance with the blocked hardeners (ketimines). The colors can be made with various color pigments suitable for paint.

A few examples, phthalo blue, phthalo green, mono-azo red, oxide red, oxide yellow, TiO2, carbon black etc.

The additives must be tested on their compatibility with the reactive components of the formulation (epoxy binder and ketimines) The amount of binder, blocked hardener and color-pigments can vary from application to application.

| Formula 16 | % w/w |
|---|---|
| Acetone | 23.80 |
| Xylene | 5.00 |
| Butyl Acetate | 15.00 |
| Wetting additive | 2.90 |
| Flow additive | 0.25 |
| Slip additive | 0.25 |
| Epoxy binder (eq.w. 500, 755 in xylene) | 14.00 |
| Ketimine (eq.w. 76) | 1.70 |
| Oleic acid | 0.10 |
| Mix of color pigments | 5.00 |
| Di-Methyl Ether | 32.00 |
| water content before filling in the aerosol can | |
| 332 ppm gives a water content in the can of | |
| 225 ppm | |

Formula 17

| | |
|---|---|
| Acetone | 16.36 |
| Xylene | 5.00 |
| Butyl Acetate | 15.00 |
| Wetting additive | 2.90 |
| Flow additive | 0.25 |
| Slip additive | 0.25 |
| Epoxy binder (eq.w. 235) | 16.00 |
| Ketimine (eq.w. 55) | 3.74 |
| Benzoic acid | 1.50 |
| Mix of color pigments | 7.00 |
| Di-Methyl Ether | 32.00 |
| water content before filling in the aerosol can | |
| 210 ppm gives a water content in the can of | |
| 143 ppm | |

Properties of Paint Film of Paint Dispersions Presented in Formulas 1-6

### EXAMPLE 1

PU clear coat Consumer quality

Gloss (angle 60°) 95-100

Film thickness 1 cross layer 40 μm

Adhesion to metal 385 MPa

Hardness after 24 h ambient 68 König

Hardness alter 15 min. IR drying 75° C. 78 König

Hardness after 48H 100

Pencil Hardness H6 passed

Water resistance after 1H ambient drying

Gasoline resistance after 1H ambient drying

### EXAMPLE 2

Pu clear coat semi-gloss

Gloss (angle 60°) 50-75

Film thickness 1 cross layer 40 μm

Adhesion to metal 379 MPa

Hardness after 24 h ambient 73 König

Hardness after 15 min. IR drying 75° C. 83 König

Hardness after 48H 110

Pencil Hardness H6 passed

Water resistance after 1H ambient drying

Gasoline resistance after 1H ambient drying

### EXAMPLE 3

Pu clear coat Matt

Gloss (angle 60°) 0-15

Film thickness 1 cross layer 40 μm

adhesion to metal 389 MPa

Hardness after 24 h ambient 79 König

Hardness after 15 min. IR drying 75° C. 88 König

Hardness after 48H 118

Pencil Hardness H6 passed

Water resistance after 1H ambient drying

Gasoline resistance after 1H ambient drying

### EXAMPLE 4

Primer Epoxy based

Film thickness 1 cross layer 30 μm

Adhesion to metal 379 MPa

Hardness after 24 h ambient 63 König

Hardness after 15 min. IR drying 75° C. 69 König

Hardness after 48H 84

Pencil Hardness H6 passed

Water resistance after 15 min IR drying

Gasoline resistance alter 15 min IR drying.

Sand able after 15 min IR drying

### EXAMPLE 5

Filler Epoxy based

Film thickness 1 cross layer 40 μm

Adhesion to metal 379 MPa

Hardness after 24 h ambient 63 König

Hardness after 15 min. IR drying 75° C. 69 König

Hardness after 48H 84

Pencil Hardness H6 passed

Water resistance after 15 min IR drying

Gasoline resistance after 15 min IR drying.

Sand able after 15 min IR drying

### EXAMPLE 6

Pigmented colored top coat Epoxy based

Gloss (angle 60°) 95-100

Film thickness 1 cross layer 40 μm

Adhesion to metal 415 MPa

Hardness after 24 h ambient 63 König

Hardness after 15 min. IR drying 75° C. 69 König

Hardness after 48H 84

Pencil Hardness H6 passed

Water resistance after 15 min IR drying

Gasoline resistance after 15 min IR drying.

Sand able after 15 min IR drying

### EXAMPLE 7 (GENERAL WORKING EXAMPLE)

General example for preparing a liquid intermediate product for an aerosol formulation (paint dispersion)

General Principles:

The solvents used in the formulations contain water

### EXAMPLES

| | |
|---|---|
| Acetone | 1300 ppm |
| Butyl acetate | 450 ppm |
| Xylene | 150 ppm |
| MPA | 700 ppm |
| Methyl Isobutyl Ketone | 450 ppm (MIBK) |

Before mixing in the active ingredients like binder and additives most of the water is removed by chemical reaction p-Tosyl [symbol] + H2 sulfoamid + CO2

Removing the excess amount of water prior adding liquid mixture into an aerosol can is preferably done in following way:

Water content of solvent(s) and propellant is 500-6000 ppm.

At least the moisture present in solvent should be reacted away. The water is reacted away by addition of sulfonyl isocyanate. For example, 12-24 gram of p-toluenesulfonyl isocyanate can react 1 gram of water away. The rest products of this moisture removing reaction is CO₂ and an inert sulfonamide.

Tests had showed that when reacting 10000 ppm of water with sulfonyl-isocyanate the reaction product sulfonamide do not disturb even with high concentrations the film forming process and clear varnish can be prepared The CO₂ will be removed by gently stirring.

After this process the formulation id finished and filtered (10 μm) before filling in the aerosol can.

During the finishing of the liquid phase (to be filled in the aerosol can) water will be picked up from the air while the mixing is done under ambient conditions.

This water will have no influence on the shelf (Shelf life of at least 2 years) life of the end product while there is present in the end product a Ketone. a Carboxylic acid pKa 2.7-5.5. This mixture will provide an environment for the Schiff's base reaction. Resulting in no free amino groups to react with either isocyanate or epoxy components.

Remark: The water content is determined with Karl fisher coulometer titration

Water content of the liquid will vary between 200 and 700 ppm resulting in a water content in the end product (liquid phase+liquified propellant) of 120 till 500 ppm.

Mixing Order and Principles.

The necessary ketone containing solvents are mixed together for forming solvent system. In a case paint dispersion which will give semi-gloss or matt paint surface (end product) is to be prepared, the necessary matting agents (primer or filler) are dispersed into the solvent system using high shire mixing. The water content of this mixture containing solvent system and possible matting agents is determined by Karl Fisher titration. Based on the determined water content of mixture the amount of sulfonyl-isocyanate is calculated and added to the mixture.

The reaction between sulfonyl-isocyanate with water present in solvent system and possible mattening agents is ready within approximately 15 minutes.

Again, a sample is taken and the water content or absent of this solvent system and possible mattening agents is again determined by Karl Fisher titration. If the water content is below 50 ppm the rest of raw materials for making paint, primer or clear coat can be added into said mixture of solvent system and possible mattening agents to make a liquid mixture by stirring gently.

Due to the fact the liquid mixture to be sealed into an aerosol can is prepared under atmospheric conditions, the following safety net is built into the liquid mixture. The safety is based on the Shiff's base principle that an amine in the presence of a ketone will react to a ketimine/imine in the presence of a catalytic presence of a weak acid. Therefore, acetone and MEK may be used as ketone containing solvents. All blocked hardeners will all form an amine in presence of water and in the case of aldimine and oxazolidine blocked hardener will form and amine and a polyol in the presence of water.

To avoid the forming of epoxy/polyurethane hardening amines catalytic amount of weak acid (pKa for example 3.5-6) is also added into liquid mixture, to create circumstances for the forming of Shiff's bases. When liquid mixture is filled into an aerosol can weak acid will continuously prevent epoxy resin or/and polyurethane resin hardening compounds. Test have shown that using this principle paint dispersion in the aerosol will be stable of a period of at least 3 years. The threshold value of the water content in the filled product is app. 50-1000 ppm preferable 50 500 ppm. depending on the type of paint dispersion inside the can (epoxy, polyurethane)

1. A method for reducing water content of an epoxy or/and polyurethane paint dispersion to be prepared in a sealed and pressurized aerosol can which paint dispersion comprised:
free water of an amount W1;
organic solvent(s) of an amount W2;
epoxy or/and polyurethane resin of an amount W3;
liquefied propellant of an amount W5;
ketone of an amount W6;
blocked hardener (hardener precursor) compounds of the epoxy or/and polyurethane resin of an amount W4, wherein said blocked hardener compounds of said epoxy or/and polyurethane resin is selected from the group consisting of an aldimine, an enamine, an imine, a ketimine, a Mannich base, a Schiff's base, an oxazolidine or a bisoxazolidine, and mixtures thereof;
adjuvants;
water scavenger(s);
a catalytic amount of a weak acid to shift equilibrium of reversible reaction (I) between the free water present in said dispersion and blocked hardener compounds of the epoxy or/and polyurethane resin back to formation of said initial epoxy or polyurethane blocked hardener compounds and to prevent formation of the epoxy or/and polyurethane hardener amines: 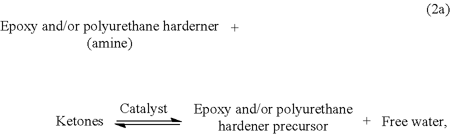
wherein before providing organic solvent into the aerosol can water content of the organic solvent is reduced by admixing reactant with sulfonyl isocyanate functionality as a water scavanger into said organic solvent.

2. The method according to claim 1, wherein after admixing water scavenger into solvent:
adjuvants, weak acid and liquid epoxy or/and polyurethane resin is mixed with the solvent to make a liquid mixture and thereafter;
blocked hardener (hardener precursor) of the epoxy or/and polyurethane resin is admixed into the liquid mixture to form a paint making dispersion; and
the paint making dispersion is directed into an aerosol can; and
the propellant is provided into said can and sealing the can.

3. The method according to claim 1, wherein the water scavenger is a reactant with sulfonyl isocyanate functionality, preferably p-toluenesulfonyl isocyanate.

4. The method according to claim 3, wherein the amount of p-toluenesulfonyl isocyanate to be admixed with the organic solvent depends of the water content of the organic solvent and is between 0.2-10% w/w, preferably 0.2-4% w/w.

5. The method according to claim 4, wherein the water content of the organic solvent is 1-6000 ppm, more specifically 100-1000, preferably 200-700 ppm before admixing with p-toluenesulfonyl isocyanate and the water content of the organic solvent is reduced by mixing 10.0-22.0 g, preferably 11-13 g p-toluenesulfonyl sulfonylisocyanate reactant with each gram of water present in said solvent.

6. The method according to claim 4, wherein the amount of water present in organic solvent is estimated or measured.

7. The method according to claim 6, wherein the water content of organic solvent is measured by Karl Fischer titration test.

8. The method according to claim 1, wherein that the water content of organic solvent is reduced from 100-2500 ppm into range of 1-500 ppm, 0-200 ppm or 0-50 ppm by admixing sulfonylisocyanate reactant into the organic solvent.

9. The method according to claim 1, wherein the organic solvent is a solvent system which contains ketone.

10. The method according to claim 9, wherein the organic solvent comprises 1-4 organic solvents.

11. The method according to claim 1, wherein the only water scavenger present in said epoxy or/and polyurethane paint dispersion present in the sealed and pressurized aerosol can is sulfonylisocyanate reactant, preferably p-toluenesulfonyl isocyanate.

12. The method according to claim 11, wherein the amount of p-toluenesulfonyl isocyanate is 0.1-4% w/w calculated from the amount of total epoxy or/and polyurethane paint dispersion in the aerosol can.

13. The method according to claim 1, wherein during entire retention time of said paint dispersion the reversible reaction 2a takes place and prevents the formation of epoxy or/and polyurethane hardener amines and keeps the amount W1 of free water and the amount W2 of said epoxy or/and polyurethane resins and the amount W3 of said hardener precursor of said epoxy or/and polyurethane resins constant between uses.

14. The method defined in claim 1, wherein said reversible reaction 2a takes place between two sequential uses of paint dispersion.

15. The method defined in claim 14, wherein said reversible reaction (2a) enables a retention time up to 3 years preferably up to 5 years.

16. The method according to claim 15, wherein the free water content W1 of the epoxy or/and polyurethane paint dispersion in the aerosol can is between 50-2000 ppm, or between 50-1000 ppm, or between 50-500 ppm.

17. The method defined in claim 1, wherein the weak acid is fatty acid such as oleic acid or carboxylic acid (XCOOH), which fatty acid or carboxylic acid selected from the group having pKₐ value in the range from 1.2 to 9, preferably in the range of 1.2-5.2.

18. The method defined in claim 17, wherein the catalytic amount of the weak acid is from 0.001 to 10% by weight (w/w) of the paint dispersion, preferably from 0.05 to 5%, more preferably from 0.05 to 2%.

19. The method defined in claim 17, wherein the weak acid is carboxylic acid selected from the group consisting of: formic acid, acetic acid, propionic acid, butyric acid, valeric acid, caproic acid, oxalic acid, lactic acid, malic acid, citric acid, benzoic acid, and mixtures thereof.

20. The method defined in claim 17, wherein the weak acid comprises propionic acid, acetic acid, benzoic acid or mixtures thereof.

21. The method defined in claim 1, wherein the resin to be added in said paint dispersion is a polyurethane resin selected from the group consisting of MDI, HDI, IPDI, TDI and phenol blocked TDI prepolymers.

22. The method defined in claim 1, wherein resin to be added in said paint dispersion is epoxy resin selected from the group consisting of an acrylic dispersion or an acrylic emulsion, an alkyd resin, an oil-modified alkyd resin, an epoxy resin, a polyurethane-modified alkyd resin, a styrene-butadiene emulsion, and a styrene-butadiene dispersion.

23. A method of preparing epoxy or/and polyurethane paint dispersion into a sealed and pressurized aerosol can, from which paint dispersion the amount of water has been reduced by means of the method defined in claim 1, which paint dispersion comprises:
free water of an amount W1 which amount W1 is between 50-2000 ppm, preferably between 50-1000 ppm from the weight of the paint dispersion;
organic solvent(s) of an amount W2;
epoxy or/and polyurethane resin of an amount W3;
liquefied propellant of an amount W5;
ketone of an amount W6;
blocked hardener (hardener precursor) compounds of the epoxy or/and polyurethane resin of an amount W4, wherein said blocked hardener compounds of said epoxy or/and polyurethane resin is selected from the group consisting of an aldimine, an enamine, an imine, a Mannich base, a Schiff's base, an oxazolidine or a bisoxazolidine, and mixtures thereof;
adjuvants; and
water scavenger(s);
which paint dispersion additionally comprises:
a catalytic amount of weak acid to shift equilibrium of reversible reaction (2a) established between the free water present in said dispersion and blocked hardener compounds of the epoxy or/and polyurethane resin back to formation of said initial epoxy or polyurethane blocked hardener compounds and to prevent formation of the epoxy or/and polyurethane hardener amines according to reversible reaction (2a): 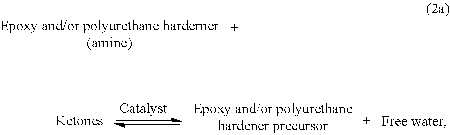
wherein
before providing the organic solvent into the aerosol can its water content of the organic solvent is reduced by admixing sulfonyl isocyanate reactant as a water scavenger into said organic solvent; and
reacting the reactant with sulfonyl isocyanate functionality with free water supplies additionally sulfonamide into said paint dispersion of an amount W7.

24. The method of preparing a paint film onto a target surface which method comprises preparing epoxy paint dispersion or/and polyurethane paint dispersion into the sealed and pressurized aerosol can according to claim 23, and further comprises spraying epoxy paint dispersion out from the can, thus enabling humidity, present in surrounding environment to react with the epoxy hardener compound having amine functionality to form on the target surface a cured epoxy paint film.

25. The method according to claim 24, wherein after 24 h drying König hardness 63 is achieved when film thickness is 30-40 um.

26. The method of preparing a paint film onto a target surface which method comprises preparing polyurethane paint dispersion into the sealed and pressurized aerosol can according to claim 23 and further comprises spraying polyurethane paint dispersion out from the can, thus enabling humidity, present in the surrounding environment to react with the amine functionality of the polyurethane hardener compound and then to form on the target surface the cured polyurethane paint film.

27. The method defined in claim 26, wherein after 24 h drying at least König hardness 63 is achieved when film thickness is 30-40 um.

28. The method defined in claim 27, wherein gloss 10-100 is achieved.

29. An epoxy or/and a polyurethane paint dispersion in a sealed and pressurized aerosol can from which paint dispersion the amount of water has been reduced by means of the method defined in claim 1, which paint dispersion contains:
(a) epoxy or/and polyurethane resin 3-15, % w/w;
(b) blocked hardener of epoxy or/and polyurethane resin defined in (a) 1-5% w/w;
(c) organic solvent 10-50% w/w;
(d) propellant, especially DME 15-40% w/w;
(e) color or primer pigments up to 15%;
(f) adjuvants up to 5 w/w %;
(g) free water 50-2000 ppm, or 50-1000 ppm, or 50-500 ppm;
(h) weak acid 0.01-10% w/w, or 0.05-5 w/w, Or 0.05-2% w/w′ which weak acid is carboxylic acid (XCOOH), selected from the group consisting of carboxylic acids which have the pKₐ value in the range from 1.2 to 9, preferably 1.2-5.2;
(i) sulfonamide, preferably p-toluene sulfonamide, of an amount 0.2-10% w/w, preferably 0.2-4% w/wp;
wherein the amount of compounds (a)-(f), (i) adds up to 90% w/w of the total weight of the paint forming solution and the rest of the solution comprises carbinolamines, (h) weak acid, (g) free water and (j) sulfonamide, preferably p-toluene sulfonamide.

30. The epoxy or/and polyurethane paint dispersion defined in claim 29, wherein the paint forming dispersion includes also other water scavengers than sulfonylisocyanate reactant, which other water scavengers are selected from the group consisting of oxazolidine, zeolite, calcium carbide, activated carbon, silica, activated alumina, CaSO₄, CaO, metal alkoxides and clay.

31. The epoxy or/and polyurethane paint dispersion defined in claim 29, wherein the paint dispersion adjuvant is selected from the group consisting of a pigment stabilizer, a corrosion inhibitor, a filler, a thickener, a bedding, a drying accelerator, a viscosity regulator, a mold inhibitor, and a foam inhibitor.

32. The epoxy or/and polyurethane paint dispersion defined in claim 29, wherein the liquified propellant is dimethyl ether (DME).

33. The epoxy or/and polyurethane paint dispersion defined in claim 29, wherein the imine is a reaction product of ethylenediamine and methyl isobutyl ketone; diethyl ketone-based di-imine, preferably N,N′-di(1-ethylpropylidene)-m-xylylenediamine; or mixtures thereof.

34. The epoxy or/and polyurethane paint dispersion defined in claim 29, wherein the enamine is a reaction product of 3,3,5-trimethylcyclohexanone with secondary diamines; a reaction product of isophoronediamine and methyl isobutyl ketone; or N,N, bis(1,3-dimethylbutylidine)ethylenediamine

35. The epoxy or/and polyurethane paint dispersion defined in claim 29, wherein the Mannich base is dimethylaminomethylphenol.

36. The epoxy or/and polyurethane paint dispersion defined in claim 29, wherein the aldimine is oxazolidine or bisoxazolidine.

37. The epoxy or/and polyurethane paint dispersion defined in claim 36, wherein the aldimine is 3-oxazolidineethanol,2-(1-methylethyl)-,3,3-carbonate or N-butyl-2-(1-ethyl-pentyl)-1,3-oxazolidine.

38. The epoxy or/and polyurethane paint dispersion defined in claim 29, wherein the solvent or its reaction product is ketone such as acetone, methyl ethyl ketone, butyl acetal or ethyl acetal.

39. The epoxy or/and polyurethane paint dispersion defined in claim 29, wherein resin is
epoxy resin which is selected from a group consisting of bisphenol A epoxy resin, bisphenol F epoxy resin, novolac epoxy resin, aliphatic epoxy resin, glycidylamine epoxy resin, and mixtures thereof; or
polyurethane resin which is selected from the group consisting of MDI, HDI, IPDI, TDI and phenol blocked TDI prepolymers.

40. The epoxy or/and polyurethane paint dispersion defined in claim 29, wherein the amount of water scavengers to be used for preparing said epoxy or/and polyurethane paint dispersion is such, that
in a case paint surface to be made has a high gloss (gloss 70-100), p-toluene sulfonamide 0.2-10% w/w is present,
in a case paint surface to be made has a low gloss (gloss 0-10), p-toluene sulfonamide over 10% w/w is present.

41. An epoxy or/and polyurethane paint dispersion in a sealed and pressurized aerosol can from which paint dispersion the amount of water has been reduced by the method defined in claim 1, which paint dispersion contains:
(a) epoxy or/and polyurethane resin 3-15, % w/w;
(b) oxazolidine 1-5% w/w;
(c) organic solvent, which includes ketone 10-50% w/w;
(d) DME 15-40% w/w;
(e) color or primer pigments up to 15;
(f) adjuvants up to 5 w/w;
(g) free water 700-1000 ppm;
(h) weak acid 0.01-10% w/w, 0.05-5 w/w, or 0.05-2% w/w which weak acid is a carboxylic acid (XCOOH), selected from the group of acids which have the pKₐ value in the range from 1.2 to 9, preferably 1.2-5.2;
(i) p-toluene sulfonamide of an amount 0.2-10% w/w, or of an amount 0.2-4% w/w
wherein the amount of compounds (a)-f), adds up to 90% w/w of the total volume of the paint forming solution and the rest of the paint forming solution comprises carbinolamines, (h) weak acid, (g) free water and (j) sulfonamide, preferably p-toluene sulfonamide.

42. A liquid mixture for preparing an epoxy or/and a polyurethane paint dispersion in a sealed and pressurized aerosol can by using method defined in claim 1, which liquid mixture has been prepared by admixing following chemicals in any order with each other: a solvent, a ketone, a weak acid, a blocked hardener precursor for epoxy resin or/and polyurethane resin having at least amine functionality, wherein
said blocked epoxy or/and polyurethane hardener precursor for epoxy resin or/and polyurethane resin is selected from the group consisting of an imine, an enamine, a ketimine, a Mannich base, a Schiff's base, an aldimine, an oxazole preferably an oxazolidine, and mixtures thereof to be used with said weak acid for preventing epoxy resin hardener compounds or/and polyurethane resin hardener compounds to be formed from said blocked epoxy or/and polyurethane hardener precursor,
optional epoxy resin is selected from the group consisting of bisphenol A epoxy resin, bisphenol F epoxy resin, novolac epoxy resin, aliphatic epoxy resin, glycidylamine epoxy resin, and mixtures thereof,
optional possible polyurethane resin is selected from the group which comprises MDI, HDI, IPDI, TDI and phenol blocked TDI prepolymers wherein said liquid mixture further comprises-free water, brought alongside with said chemicals; and
reactant with sulfonyl isocyanate functionality, for reducing free water content of liquid mixture has been admixed into said liquid mixture.

43. The liquid mixture according to claim 42, wherein the amount of free water present in liquid mixture is in a range of 1-10000 ppm, preferably in a range of 1-6500 ppm before adding reactant with sulfonyl isocyanate functionality and in range of 100-2500 after reactant with sulfonyl isocyanate functionality has been reacted with chemicals, preferably with the solvent.

44. The liquid mixture defined in claim 43, wherein the amount of reactant with sulfonyl isocyanate functionality depends on the amount of moisture present in liquid mixture, preferably in solvent(s).

45. The liquid mixture defined in claim 43, wherein then the amount of the of reactant with sulfonyl isocyanate functionality depends also of the amount of adjuvants such as matting agents.
